(19) United States
(12) Patent Application Publication
(10) Pub. No.: US 2014/0367974 A1
(43) Pub. Date: Dec. 18, 2014

(54) Latch for Securing a Storage Container

(71) Applicant: Joshua W. Keely, Hiram, GA (US)

(72) Inventor: Joshua W. Keely, Hiram, GA (US)

(21) Appl. No.: 13/920,738

(22) Filed: Jun. 18, 2013

(51) Int. Cl. E05B 65/00; E05B 15/00

(52) U.S. Cl. CPC E05B 65/0014; E05B 15/00
USPC 292/60; 292/57

(57) ABSTRACT

A latch for securing a storage container is described, and which includes a longitudinally moveable spindle member, which extends and is otherwise biasingly supported by a closure member, and which is mounted on and moveable relative to the storage container; a pinion mounted on a distal end of the spindle, and which forcibly engages an elongated locking member; and a latch control collar mounted on the spindle, and which, when selectively moved, allows the spindle to be selectively rotated so as to locate the locking member in given positions so as to secure the closure member.

### TECHNICAL FIELD

The present invention relates to a latch for securing a storage container, and more specifically to a latch which has particular utility when securing storage containers against access by children, and which further is easy to operate, and reliable in operation.

### BACKGROUND OF THE INVENTION

Assorted latching mechanisms have been developed through the years for a number of different applications. For example, various door bolts have been developed and have been known for a long periods of time. Examples of such door bolts include U.S. Pat. No. 61,185 which issued on Jan. 15, 1867; and U.S. Pat. No. 189,438, which issued on Apr. 10, 1877. The teachings of these particular patents are incorporated by reference herein. Additionally, and for some applications, users have sought after a latch mechanism which could be rendered operable only in a particular operational condition, such as when pressure was applied to an actuator. An example of such a patent is found in U.S. Pat. No. 2,786,706, and which was issued on Mar. 26, 1957.

Moreover, as time has passed, other developers have tried to provide various childproof lock or latch arrangements, which prohibit children from gaining access to storage containers; cabinets; drawers and the like. An example of such a design is found in U.S. Pat. No. 3,206,238, which issued on Sep. 14, 1965. Other attempts to design such safety latch or locking mechanisms can also be seen in U.S. Pat. No. 3,860,276; and U.S. Pat. No. 4,136,898, to name but a few. Other more recent attempts to design safety latches to prevent access to storage areas or regions can be seen in U.S. Pat. No. 5,280,974; and U.S. Pat. No. 6,431,616.

While all these previous products have worked with various degrees of success, many problems have been experienced when implementing and utilizing same. Chief among the shortcomings associated with such prior art designs has been the propensity for such latching arrangements to require rather substantial installation time. On the one hand, some latch assemblies require a substantial alteration of the door or other closure member on the storage container. In still other arrangements, the latches are unduly cumbersome, and complex in design and in operation. In view of their relative complexity, the cost of such latches has been sometimes cost-prohibitive. Moreover, many of these same assemblies often require the use of alternative exterior hardware on the door, or other closure member which is employed with the storage container. This is often undesirable from a homeowner's standpoint because such exterior hardware often does not match the hardware which is usually employed on adjacent cabinets or other doors.

Therefore, a long felt need has existed for a reliable, cost-effective latch for securing a storage container which can be easily installed without substantial alteration to the door or other closure member, and which further allows a homeowner to employ the hardware typically associated with that same door, closure member, or drawer.

### SUMMARY OF THE INVENTION

A first aspect of the present invention relates to a latch for securing a storage container which includes a storage container having a sidewall which defines an internal cavity, and an aperture which allows access to the internal cavity; a closure member movably cooperating with the storage container, and which further selectively occludes the aperture, and prevents access to the internal cavity, and may be further located in a non-occluding position which allows access to the internal cavity; a spindle having a main body which passes through the closure member, and which is further longitudinally, and rotatably moveable relative to the closure member, and wherein the main body of the spindle has opposite first, and second ends; an elongated locking member which is oriented in force receiving relation relative to the spindle, and wherein the rotation of the spindle imparts force to the elongated locking member to move the elongated locking member along a path of travel into, and out of engagement with the sidewall of the storage container so as to selectively retain the closure member in the occluding position relative to the aperture, and which is defined by the storage container, or allow the closure member to be moved to the non-occluding position relative to the aperture as defined by the storage container; and a latch control collar which is mounted on the spindle, and which is moveable along a course of travel, from a first position, which substantially prevents rotation of the spindle, and any subsequent movement of the elongated locking member, and a second position, which allows the spindle to be simultaneously rotated so as to impart movement to the elongated locking member.

Still another aspect of the present invention relates to a latch for securing a storage container, which includes a closure member having opposite, inside and outside facing surfaces, and which is further moveably mounted on a storage container that has an internal cavity, and which further defines an aperture which allows access into the internal cavity, and wherein the closure member is moveable relative to the storage container between a first position, where the closure member occludes the aperture, and prevents access to the internal cavity, and a second, spaced position, which allows access to the internal cavity, and wherein the storage container has a frame member which defines, at least in part, the aperture, and wherein a latch aperture is formed in, and passes through the inside and outside facing surfaces of the closure member; a latch housing mounted on the inside facing surface of the closure member, and wherein the latch housing is defined by a sidewall which has a first aperture which is substantially coaxially aligned with the latch aperture formed in the closure member, and a second aperture, and wherein the latch housing further has an internal cavity which defines a guidance channel which is aligned, at least in part, with the latch aperture, and a locking member passageway which is substantially aligned with the second aperture and which is defined by the latch housing; an elongated spindle having a main body which extends through the latch aperture, and which further has a first end, which is located in spaced relation relative to the outside facing surface of the closure member, and a second end, which is located in spaced relation relative to the inside facing surface thereof, and within the internal cavity of the latch housing; a biasing member which acts upon the elongated spindle, and which further is located within the latch housing, and wherein the biasing member urges the spindle to move longitudinally, inwardly toward the internal cavity of the latch housing; a pinion mounted on the second end of the elongated spindle, and which is further located within the locking member passageway, and wherein the pinion is co-rotatable with the spindle, and is further slidably moveable along the spindle between the first and second ends thereof; a locking member having an elongated main body with opposite first and second ends, and a top and bottom surface, and wherein the elongated main body is received within the locking member passageway, and is reciprocally moveable along a path of travel between a first, extended position, where the second end of the locking member extends outwardly through the second aperture as defined by the latch housing, and which engages the frame member of the storage container, and thereby secures the closure member in the first occluding position relative to the aperture which is defined by the storage container, and a second, retracted position, and wherein in the second, retracted position, the second end of the locking member is moved to a location where the second end does not engage the frame member, and the closure member is able to be moved to the second position which allows access to the internal cavity of the storage container, and wherein a rack is formed in the bottom surface of the locking member and is meshingly engaged by the pinion, and wherein rotatable motion of the pinion, in a given direction, is operable to impart reciprocal motion to the locking member to move the locking member between the first and second positions thereof; and a latch control collar is mounted on the spindle, and which is co-rotatable, and simultaneously, longitudinally moveable along with the spindle, and wherein the latch control member has as an engagement member which is slidably received within, and cooperates with the guidance channel, and wherein the engagement member when received within the guidance channel, substantially prevents rotation of the spindle, and any corresponding movement of the locking member, and wherein the longitudinal movement of the spindle, and latch control member along the guidance channel, and to a location where the engagement member is no longer in the guidance channel allows the spindle to be subsequently, selectively rotated in a given direction so as to effect the reciprocal motion of the locking member into, and out of engagement with the frame member which defines the aperture of the storage container.

These and other aspects of the present invention will be discussed in greater detail hereinafter.

### BRIEF DESCRIPTION OF THE DRAWING

Preferred embodiments of the invention are described below with reference to the following accompanying drawings.

FIG. 1 is an exploded, perspective view of the latching assembly of the present invention.

FIG. 2 is a perspective, environmental view of the present invention and which is shown in a typical operational environment.

FIG. 3 is an exploded, top plan view of the latch of the present invention, and which further shows the housing, thereof, in a horizontal, sectional view.

FIG. 4 is a horizontal, sectional view of the latch of the present invention in a first operational position.

FIG. 4A is a horizontal, sectional view of the latch of the present invention and which is shown in a second, operational position.

FIG. 4B is a horizontal, sectional view of the latch of the present invention and which is shown in the third, operational position.

FIG. 4C is yet another horizontal, sectional view of the latch of the present invention, and which is shown in a fourth operational position.

FIG. 4D is still another horizontal sectional view of the latch of the present invention, and which is shown in a fifth operational position.

FIG. 4E is yet still another horizontal sectional view of the latch of the present invention, and which is shown in a sixth operational position.

FIG. 5 is a perspective, fragmentary, horizontal sectional view of a latch housing, and elongated spindle, which form features of the present invention.

FIG. 6A is a transverse, vertical sectional view taken from a position along line 6A-6A of FIG. 4, and which shows an elongated locking member in a first operational position.

FIG. 6B is a transverse, vertical, sectional view taken from a position along lines 6B-6B as seen in FIG. 4.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” [Article I, Section 8].

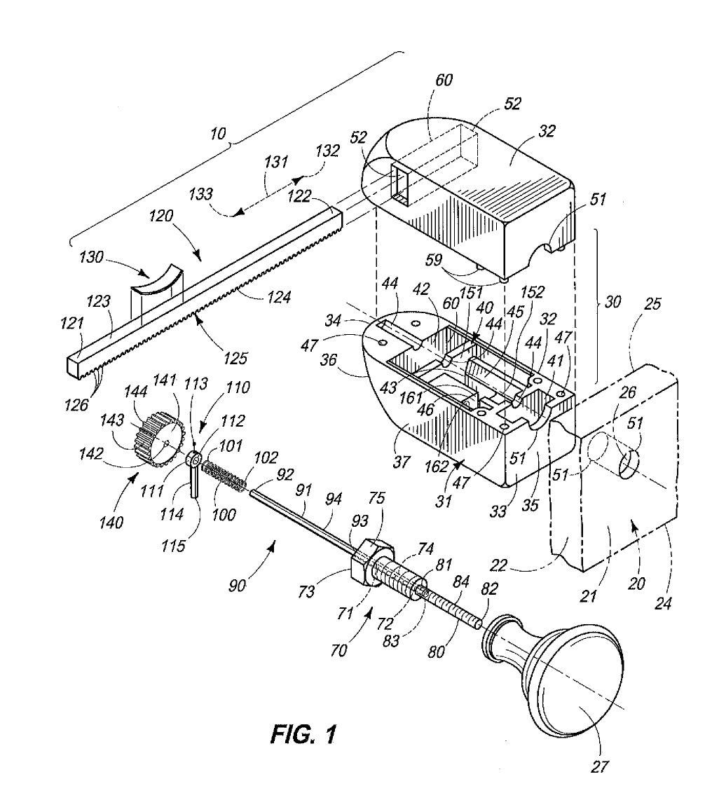

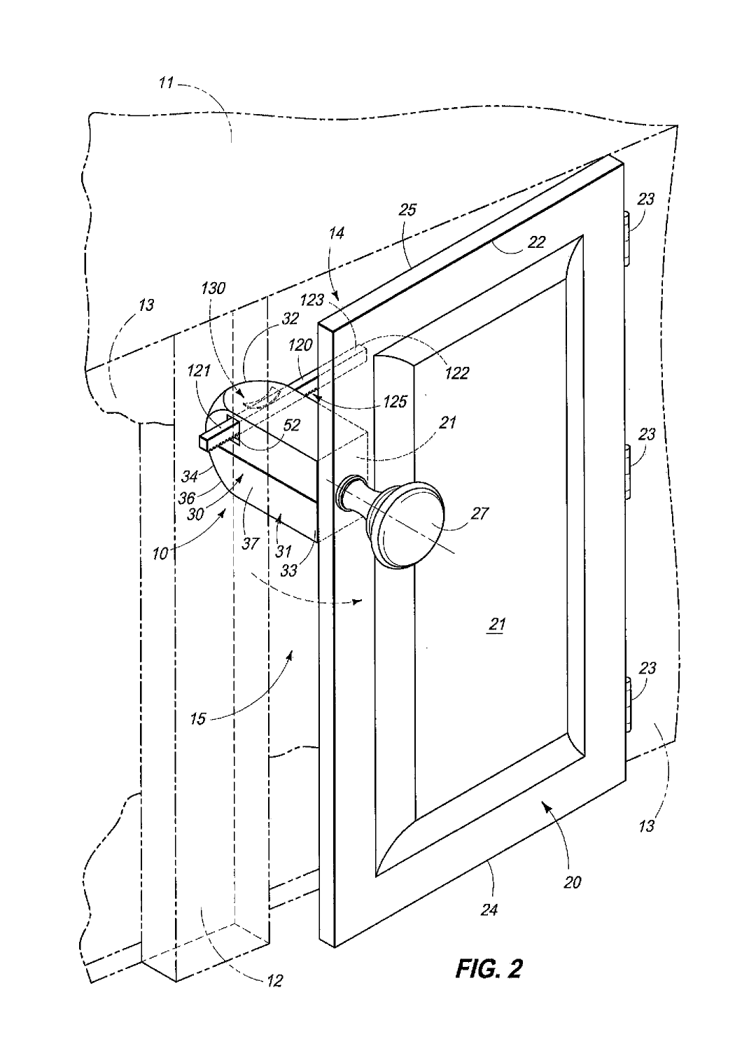

A latch for securing a storage container of the present invention is generally indicated by the numeral 10 in FIG. 1 following. As best seen by reference to FIG. 2, the latch 10 of the present invention is useful for securing the contents of a storage container, which is generally indicated by the numeral 11. The storage container, which may include a cabinet, freestanding piece of furniture or other storage region, such as a drawer is fabricated, at least in part, by a frame 12. The frame 12 supports a sidewall 13 thereon. The frame and sidewall 12 and 13, in combination define an aperture 14, which allows access to the internal cavity 15 of the storage container 11.

The latch 10, which is useful for securing the storage container 11, further operates in combination with a closure member, door, or draw face, and which is generally indicated by the numeral 20. The closure member is defined by a main body 21, having a peripheral edge 22. The main body 21 has a cross-sectional dimension, which is typically larger than the cross-sectional dimension of the aperture 14, and which is defined by the sidewall 13 of the storage container 11. Further, and coupled along one of the peripheral edges 22, and in the embodiment as seen in FIG. 2, are a plurality of hinges 23, of conventional design. The hinges are attached to the frame 12 of the storage and container 11, and allow the main body 21 to be moved between an open or non-occluding position, and a closed or occluding position. As will be understood, in the open position, the closure member allows access to the internal cavity 15 of the storage container 11. On the other hand, and in a closed position, the closure member 20 substantially occludes the aperture 14, thereby preventing access to the internal cavity 15. The main body 21 further has an outside-facing surface 24, and an opposite inside-facing surface 25. As seen in FIG. 1, an existing, latch aperture 26 is formed in the main body 21, and extends between the outside facing and inside facing surfaces 24 and 25, respectively. Still further, the closure member, door, or draw face 20 has an existing doorknob or cabinet pull, which is generally indicated by the numeral 27. The existing doorknob, or cabinet pull 27, is employed in the present invention 10, as will be discussed, below.

The latch 10 of the present invention is made integral, and works in combination with a latch housing, which is generally indicated by the numeral 30. The latch housing includes a bottom portion 31, and a top portion 32, which fits in releasable mating engagement with the bottom portion. The bottom portion 31 has a first, and an opposite second end 33 and 34, respectively. Additionally, the bottom portion 31 is defined, in part, by a substantially planar shaped, and proximal end wall 35, which rests in juxtaposed receipt, thereagainst the inside-facing surface 25 of the closure member 20. Still further, the bottom portion includes a distal end wall 36. As will be seen in the exploded view in FIG. 1 and following, the bottom portion 31 includes a pair of spaced sidewalls generally indicated by the numeral 37.

The bottom portion 31 of the latch housing 30 defines an internal cavity 40, which has first and second portions 41 and 42, respectively. Still further and as seen in FIG. 1 and following, a guidance channel 43 is located within the internal cavity 40, and further is operable to cooperate with a rotatable spindle, as will be discussed in greater detail, below. Still further, a spindle passageway 44 is formed in the internal cavity 40, and extends substantially along the longitudinal axis thereof. The guidance channel 43 is defined, in part, by a first course 45, which lies substantially along the longitudinal axis of the bottom portion 31, and which is further disposed in substantial parallel spaced relation relative to the spindle passageway 44. Still further, the guidance channel includes a second course 46, which is coupled to the first course, and which further is disposed transversely relative thereto. The operation of the first and second courses 45 and 46 will be discussed in greater detail later in this application. As seen in FIG. 1, for example, a multiplicity of engagement apertures 47 are formed in the bottom portion 41, and are operable to matingly receive engagement posts, which are made integral with the top portion 32, and which will be discussed in greater detail hereinafter.

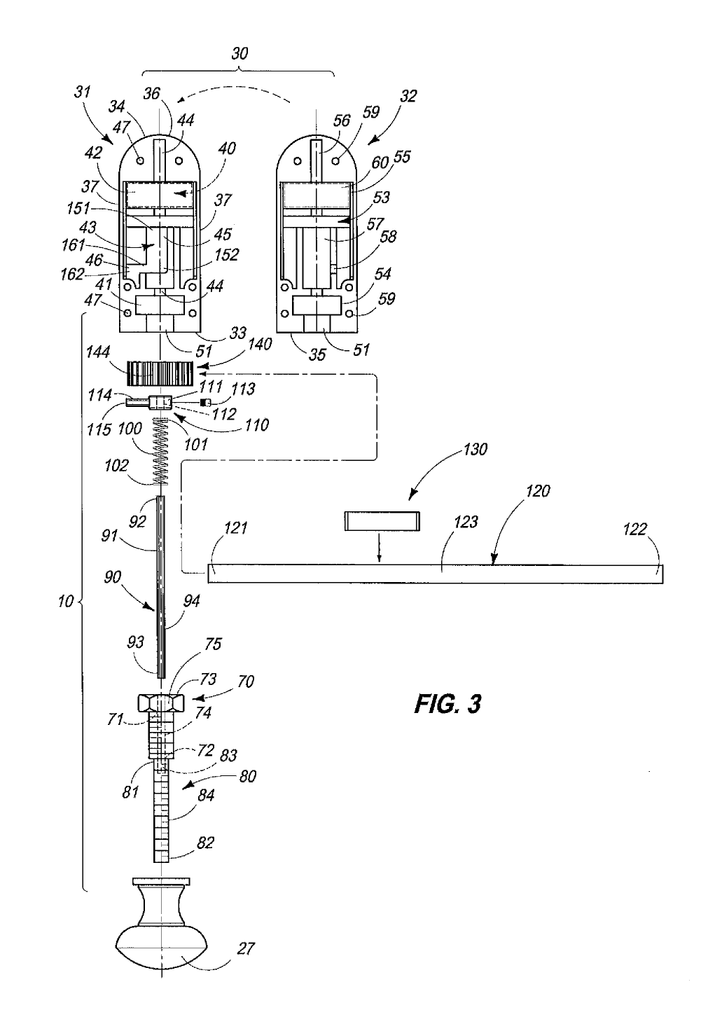

As earlier disclosed, the latch housing, which is generally indicated by the numeral 30, has bottom and top portions 31 and 32, respectively. The top and bottom portions may be secured together by threaded fasteners; adhesive; or releasable couplers which are well known in the art. As best illustrated by reference to FIG. 1, a first aperture 51 is defined by the latch housing 30, and which is substantially coaxial aligned with the latch aperture 26, and which is further formed in the closure member 20. Still further, the latch housing 30 defines a second aperture 52, which is defined by the top portion 32 of the latch housing 30. As seen, in the drawings the second aperture 52 couples to a locking member passageway 60 which extends through the top portion 32 and is operable to receive an elongated and selectively moveable locking member, which will be discussed in greater detail, hereinafter. The top portion 32 defines an internal cavity 53, which is a substantial mirror image of the internal cavity 40 of the bottom portion 31. In this regard, the internal cavity 53, again, has a first portion 54, which is operable to be matingly aligned with the first portion 41 of the bottom portion 40 when the bottom portion 31 and the top portion 32 are matingly coupled together. Again, the internal cavity 53 of the top portion 32 has a second portion 55, which is substantially aligned with the second portion 42. Additionally, a spindle passageway 56 is formed in the internal cavity 53, and substantially aligns and matingly cooperates with the spindle passageway 44. Again, the internal cavity 53 defines a first course of a guidance channel 57, which is also aligned and matingly cooperates with, the first course 45, as defined by the bottom portion 31. Additionally, the internal cavity 53 defines a second course 58, which, again, is substantially aligned with, and is a mirror image of the second course 46. As best seen by reference to FIG. 3, a plurality of engagement or coupling posts 59 extend normally downwardly from the top portion 32 and are spaced in a pre-determined pattern so as to substantially matingly engage and be received within the multiplicity of engagement apertures 47, which are formed in the bottom portion 31. As noted earlier, the top and bottom portions 32, and 31, may be held together by suitable fasteners and the like. The top portion 32 defines a locking member passageway 60 which extends between each of the second apertures 52.

As seen best in FIG. 1, the latch 10 of the present invention includes a housing mounting fastener 70, which is defined, in part, by a longitudinally extending main body 71. The fastener 70 has a threaded proximal end 72, which is operable to threadably engage and be received in and through the latch receiving aperture 26, as previously formed in the closure member 20. Still further, the main body 71 of the fastener 70 includes a distal end 73, which is received in part within the first portion 41 of the internal cavity 40 of the bottom portion 31, and further received in part in the first portion 54 of the internal cavity 53 of the top portion 32. As seen in FIG. 1, a longitudinally extending spindle receiving passageway 74 is formed through the housing mounting fastener 70, and extends between the proximal end 72, and the distal end 73. Additionally, and as seen in FIG. 1, it be recognized that the distal end 73 includes a tool engaging peripheral edge 75, which allows a user, on installation, to apply a torquing force thereto by means of a conventional wrench in order to threadably advance the distal end 73 along the aperture 26 as formed in the closure member 20, and thereafter return the main body 71 into an appropriate receiving relation within the internal cavities 40 and 53, respectively of the bottom and top portions 31 and 32.

It will be recognized that the housing mounting fastener 70 when properly threadably engaging the closure member 20 secures the bottom and top portions 31 and 32 of the latch housing 30, in a secure facing engagement relative to the inside facing surface 25 of the closure member 20, and further orients the first aperture 51 in substantially coaxial alignment relative to the aperture 26, which is formed in the closure member 20.

Again referring to FIG. 1, it will be seen that the present latch 10 includes a threaded doorknob or other engagement shaft 80. The threaded engagement shaft 80 has a first end 81, and an opposite second end 82. As illustrated in the drawings, the first end 81 has a spindle engaging cavity 83 formed therein, and which further receives one end of a spindle, and which will be discussed in greater detail in the paragraphs which follow. Still further, the second end 82 has a threaded engagement portion 84, which is operable to releasably, threadably mate with the existing doorknob or cabinet pull 27, as illustrated in the drawings. As will be appreciated, once the threaded proximal end 72 of the housing mounting fastener 70 engages the closure member 20, the existing doorknob or cabinet pull 27 may be forcibly pulled, longitudinally outwardly, thereby carrying the threaded doorknob engagement shaft 80 out through the aperture 26, which is defined by the closure member 20. Still further, the threaded doorknob engagement shaft 80 is co-rotatable with the existing doorknob or cabinet pull 27. This feature of the present invention will be discussed, below.

The present invention 10 also includes a spindle, which is generally indicated by the numeral 90, and which further has a main body 91, which passes, at least in part, through the closure member 20, and which is further longitudinally and rotatably movable relative to the closure member 20. The main body 91 has opposite first and second ends 92 and 93, respectively, and further has an intermediate portion 94. As best seen by reference to FIG. 3 and following, the second end 93 of the spindle 90 is fastened or otherwise secured within the spindle engagement cavity 83, and is therefore co-rotatable therewith. The main body is substantially coaxially aligned with the threaded engagement shaft 80.

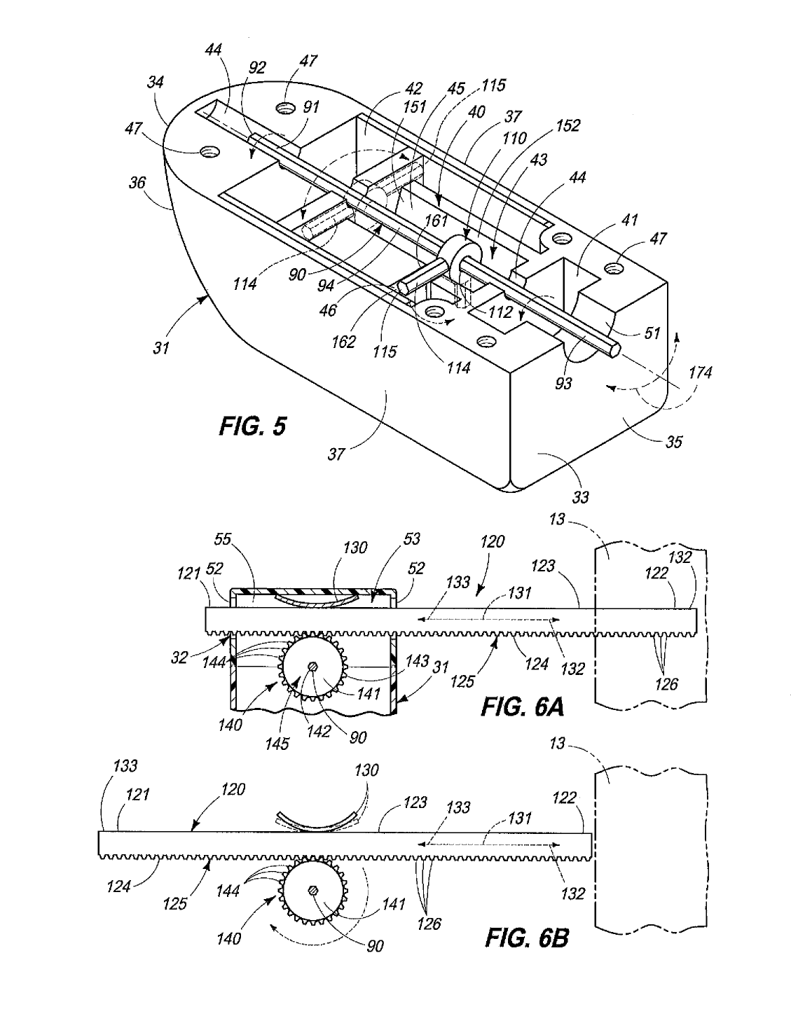

As seen in FIG. 1, and following, the present invention 10 includes a biasing spring, here illustrated as a coil spring 100, and which is received, on and about the intermediate portion 94 of the spindle 90. The biasing spring has a first end 101, and in opposite second end 102. The second end 102 is located in adjacent, spaced relation relative to the distal end 73 of the housing mounting fastener 70. The action of the biasing spring tends to bias or otherwise urge or force the spindle in a pre-determined direction so as to cause the existing doorknob 27 to be pulled and otherwise normally rest in engagement with the outside facing surface 24 of the closure member 20. Additionally, and as will be recognized in FIG. 1 and FIG. 5, a latch control collar 110 is mounted on the spindle 90, and is located in the intermediate region or portion 94. The latch control collar has a main body 111, which has a passageway 112 formed therein. Still further, a threaded fastener 113 extends through the main body 112, and forcibly engages the main body 91 of the spindle 90, so as to appropriately fixedly position the main body 111 in a predetermined orientation between the first and second ends 92 and 93 of the spindle. This attachment allows the main body 111 to co-rotate with the main body 91 of the spindle 90. Extending laterally or radially outwardly relative to the main body 111 is an engagement member 114, having a given length. The engagement member 114 has a distal end 115, which is operable to matingly cooperate, at least in part, with the guidance channel 43, as defined by the bottom and top portions 31 and 32, respectively, of the latch housing 30. This aspect of the invention will be described in greater detail below. As seen from the drawings, the spindle 90 has a journaled or otherwise a non-circular shape surface. In the drawing the exterior surface appears hexagonal in shape. Other non-circular cross-sectional shapes could also be employed. This feature of the invention is important and will be discussed in the context of the operation of the present invention.

The present invention 10 includes an elongated locking member which is herein designated by the numeral 120, and which is further oriented in force receiving relation relative to the spindle 90. In the arrangement as seen in the drawings, it should be understood that the rotation of the spindle 90 imparts force to the elongated locking member 120, so as to move the elongated locking member along a predetermined path of travel as will be described, below, into and out of engagement with the sidewall 13 of the storage container 11. This movement of the elongated locking member either selectively retains the closure member 20 in an occluding or closed position relative to the aperture 14, and which is defined by the storage container 11, or on the other hand further allows the closure member 20 to be moved to a non-occluding position or open relative to the aperture 14, as defined by the storage container 11. As seen in FIG. 1 and following, the elongated locking member has a first end 121, and a second end 122. Still further, the elongated locking member has a top surface 123, and an opposite, bottom surface 124. As illustrated, the bottom surface 124 has formed therein a rack 125, which is formed of a multiplicity of gear teeth, and which as generally indicated by the numeral 126. The present invention 10 further includes a second biasing member 130, which is received within the second portion 55, of the top portion 32, of the latch housing 30, and which is operable to exert a biasing force which is directed downwardly onto the top surface 123 of the elongated locking member 120. Again, the elongated locking member 120 is moveable along a course of travel 131, as best seen by references to FIGS. 6A and 6B, respectively. The course of travel 131 is defined between a first position 132, as seen in FIG. 6A, and wherein the second end 122 of the elongated locking member 120 is extended to a position so as to engage the sidewall 13 or frame 12 of the storage container 11 and thereby retain the closure member 20 in an occluding or closed position relative to the aperture 14 of the storage container 11. This, of course, prevents access to the interior cavity 15. Still further, the elongated locking member 120 is movable along the course of travel 131, to a second position 133 as indicated in FIG. 6B, and wherein when located in the second position 133, the second end 122 is moved out of direct contact with the sidewall 13 of the storage container 11, and thereby allows the closure member 20 to be moved to a non-occluding or open position relative to the aperture 14. This of course allows access to the interior cavity 15.

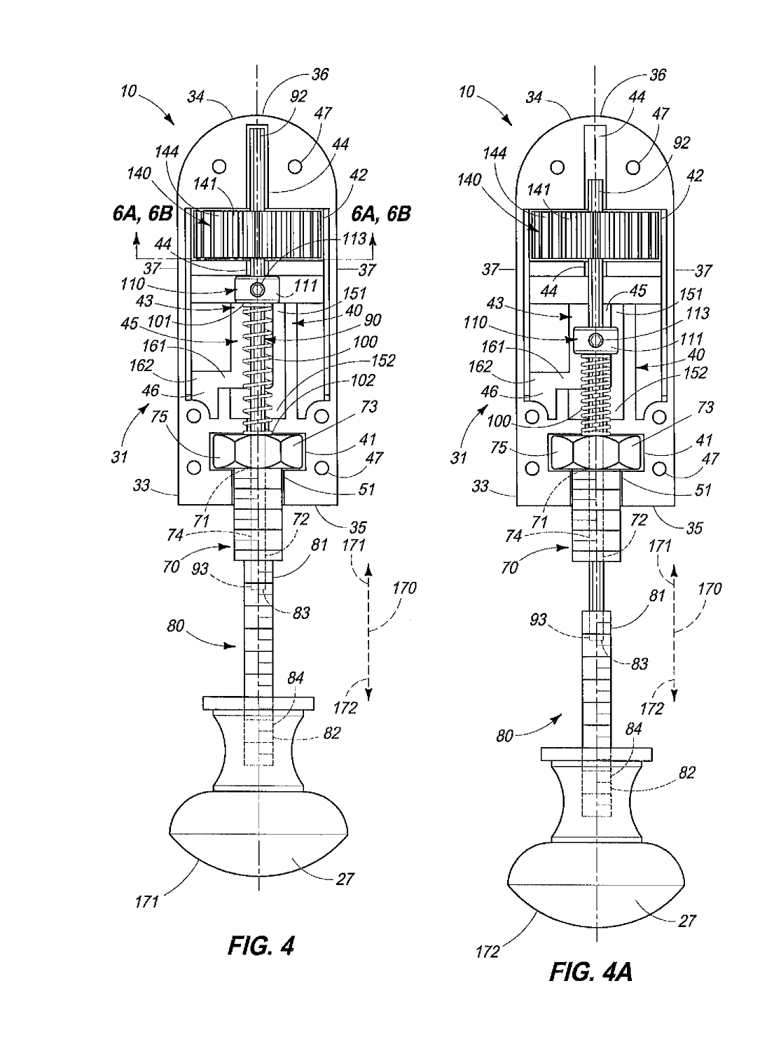

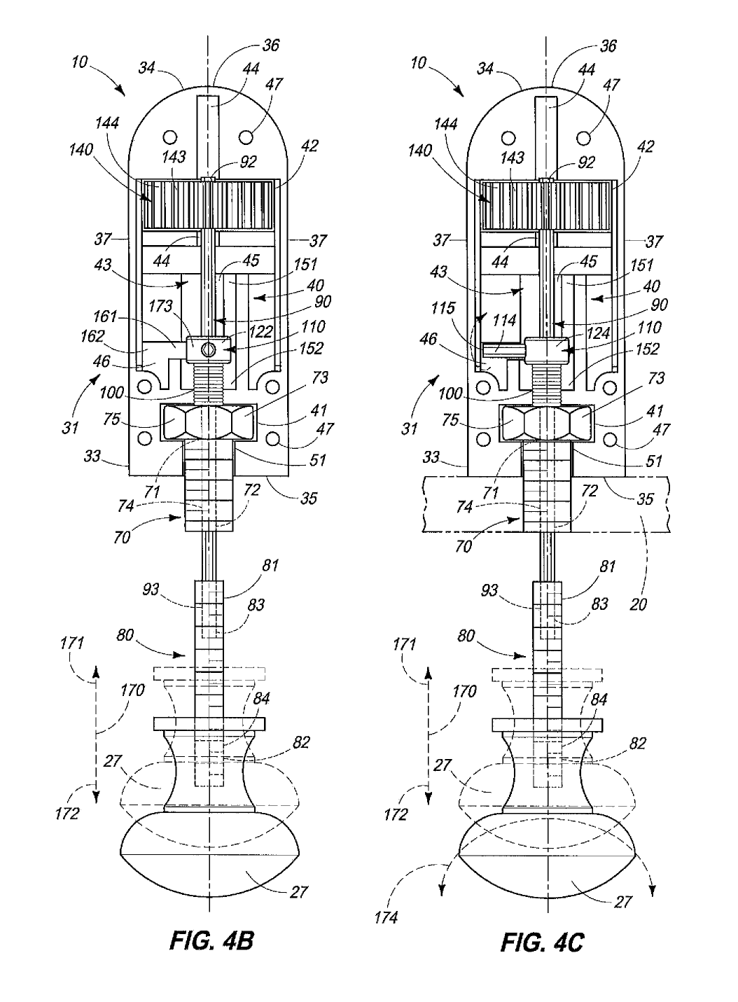

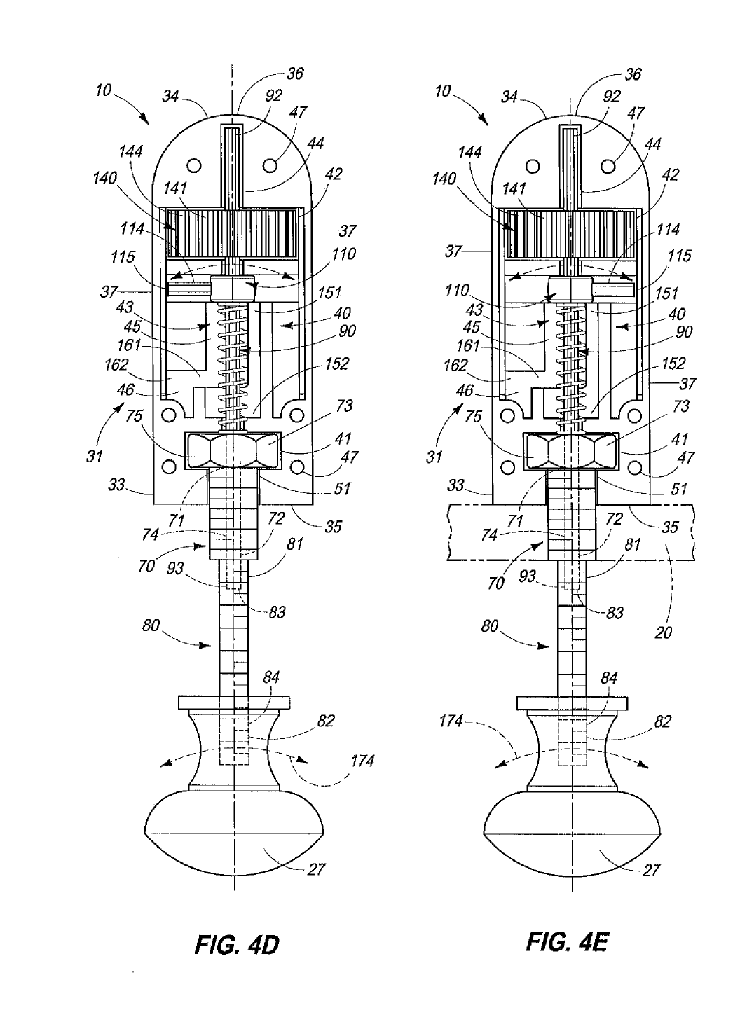

As illustrated in the drawings, a pinion 140 is provided, and which is operable to co-rotate with the spindle 90, and wherein, the pinion 140 has a main body 141 defining a non-cylindrically shaped passageway 142 which is matingly complementary in shape relative to the exterior facing surface of the spindle 90. In the arrangement as seen in the drawings, the main body of the spindle 91 is operable to be both slidably moveable through the passageway 142, and further engages the main body of pinion such that the pinion is both co-rotatable with and slidably and longitudinally moveable along the spindle 90. The main body 141 of the pinion 140 has a peripheral edge 143, which defines a multiplicity of gear teeth 144, which are dimensioned to meshingly, and forcibly engage the teeth 126, which are made integral with the rack 125. As earlier described, the rack 125 is made integral with the bottom surface 124 of the elongated locking member 120. In the arrangement as seen in the drawings, the second biasing member 130, which is positioned within the top portion 32 of the latch housing 30, is operable to exert a biasing force on the top surface 123 of the elongated locking member 120, thereby forcing the elongated locking member 120 into forceable meshing engagement with the pinion 140. It should be understood, therefor, that upon rotation of the spindle 90 the pinion 140 co-rotates with the spindle 90 and thereby imparts force, which is transmitted through the rack 125, so as to cause the elongated locking member 120 to reciprocally move along the course of travel 131 between the first and second positions 132 and 133, to accomplish the selective locking feature of the present invention 10. As noted earlier, the passageway 142 has substantially the same shape as the exterior facing surface of the spindle 90. Therefore, the spindle 90 can slidably move in a longitudinal direction along, and axially through the passageway 142. However, upon rotation of the spindle 90, the pinion 140 co-rotates therewith. As earlier discussed, the guidance channel 43, which is defined in part by the bottom portion 31 of the latch housing 30, has a first course 45, having a first end 151, and an opposite second end 152. This first course 45, which has a mirror image which is formed in the top portion 32, is disposed in substantially parallel, spaced relation relative to the elongated spindle 90, and which is positioned above same. Additionally, and as seen in the drawings, the second course 46 of the guidance channel 43, of the bottom portion 31, has a first end 161, which adjoins the second end 152 of the first course, and which further extends perpendicularly outwardly relative thereto. The second course 46 also has a second end 162. As illustrated, the guidance channel 43, looking at it from the plan view as seen in FIGS. 4A, 4B, 4C, 4D and 4E, respectively, has a substantially L-shape and allows the present invention to achieve the many benefits as will be described, below.

It should be understood from the drawings that the spindle 90, as described, is moveable along the linear course of travel, which is generally indicated by the numeral 170, and which is further defined by the spindle passageway 44. This linear course of travel is defined between a first position 171 (FIG. 4), and a second position 172 (FIG. 4A). The first position 171 is best seen by reference to FIG. 4, and wherein the latch control collar 110 is positioned at the first end 151 of the first course. In the second position 172, as best seen by reference to FIG. 4C, the latch control collar 110 is positioned at the second end 152 of the first course 45. When located in the second position 172, the spindle can be rotated along the course of travel 174, as illustrated in FIGS. 4C, 4D and 4E, respectively, so as to cause the simultaneous co-rotation of the latch control collar 110, and the associated engagement member 114. As the aforementioned rotation occurs, the engagement member 114, and more respectively the distal end 115 thereof, moves into the second course 46 of the guidance channel 43. As this event occurs, the latch control collar 110 is then located in a second position 175. Upon release of the applied outwardly directed force which is directed to the existing doorknob or cabin pull 27, the biasing force of the spring 100 is effective to move the spindle 90 back to the first position 171. When this event occurs, the engagement member 114 is located outside of the first course 45 of the guidance channel 43. Thereafter, if rotatable movement of the spindle shaft 174 is applied by exerting force on the handle, the existing doorknob or cabinet pulls 27, is effective in rotating the spindle 90, and thereby causing the co-rotation of the pinion 140. When rotation of the pinion 140 occurs, the rack 125, which is disposed in forcible meshing engagement therewith, moves the locking member 120 along the course of travel 131 as earlier described. Further, and when rotational movement 174 is directed in the opposite direction, the elongated locking member 120 reverses direction and moves between the first and second positions 132 and 133, respectively. To again place the latch 10 into an orientation where the locking member 120 is rendered inoperable, force is applied to the existing doorknob 27, thereby causing the spindle to move longitudinally outwardly relative to the housing mounting fastener 70. This action movement causes the engagement member 114, and the attached latch control collar 110 to be moved to a position such that the engagement member 114 can then reenter or otherwise be received within the second course 46 of the guidance channel 43. Once received within the second course 46, a rotation of the spindle caused by means of applying a rotational force to the existing doorknob or cabinet pull 27, causes the engagement member 114 to again be received, and be located at the second end 152 of the first course 45. Thereafter, by releasing the outwardly and longitudinally directed pressure on the existing doorknob or cabinet pull 27, the biasing spring 100 returns the spindle to the first position and causes the latch control collar 110 to be moved to the first end 151 of the first course. In this location, the engagement member 114 is received within the first course 45, and the rotation of the existing doorknob or cabinet pull 27 is impeded. Further, it will be appreciated, because of this impeded rotation, the elongated locking member 120 cannot be moved along the course of travel 131 as earlier described. Consequently, it will be recognized that it will be quite difficult for a child to utilize a latch of this design because of the several movements of the existing doorknob. However, the present latch provides conveniences for an adult user who can very quickly open and close a closure member 20, and thereby secure it relative to a storage container 11 in a manner not possible heretofore.

### Operation

The operation of the described embodiment of the present invention is believed to be readily apparent and is briefly summarized at this point.

The present invention relates very broadly to a latch 10 for securing a storage container 11, and wherein the storage container has a sidewall 13, which defines an internal cavity 15, and an aperture 14. The aperture 14 allows access to the internal cavity 15. A closure member 20 moveably cooperates with the storage container 11, and further selectively occludes the aperture 14 and prevents access to the internal cavity 15. The closure member 20 may be further located in a non-occluding position, which allows access to the internal cavity 15. The latch 10 includes a spindle 90 having a main body 91, which passes through the closure member 20, and which is further longitudinally and rotatably moveable relative to the closure member 20. The main body 91 has opposite first and second ends 92 and 93, respectively. The latch 10 of the present invention includes an elongated locking member 120, which is oriented in force receiving relation relative to the spindle 90. It should be understood that the rotation of the spindle 90 imparts a simultaneous rotational force to the elongated locking member 120 so as to move the elongated locking member 120 along a path of travel 131 into and out of engagement with the sidewall 13 of the storage container 11, so as to selectively retain the closure member 20 in the occluding position relative to the aperture 14, and which is further defined by the storage container 11. Further movement along the path of travel 131 allows the closure member 20 to be moved to a non-occluding position relative to the aperture 20, as defined by the storage container 11. In the arrangement as illustrated, the latch 10 of the present invention includes a latch control collar 110, which is mounted on the spindle, and which is further moveable along the course of travel 170 from the first position 171, which substantially prevents rotation of the spindle, and any subsequent movement of the elongated locking member 120, and a second position 172, which allows the spindle to be simultaneously rotated so as to impart movement to the elongated locking member 120.

In the arrangement as shown in the drawings, the latch 10 of the present invention includes a pinion 140, which is longitudinally and moveably mounted on the first end 92 of the main body 91 of the spindle 90, and which is further co-rotatable with the spindle 90. The elongated locking member 120 further has a rack 125, which is oriented in meshing, force receiving relation relative to the pinion 140. It should be understood that the co-rotation of the spindle 90 and the pinion 140 moves the elongated locking member 120 along the path of travel 131. As will be appreciated, at least a portion of the spindle 90 passes through an existing aperture 26, which is formed in the closure member 20. Still further, an existing handle 27 from the closure member 20, is releasably affixed to the second end of the spindle 90, and can be forcibly engaged to cause longitudinal and rotational movement of the spindle 90 relative to the latch housing 30.

The latch 10 of the present invention, as earlier disclosed, includes a closure member 20, which has an outside-facing surface 24, and an opposite inside-facing surface 25. A latch aperture 26 is formed in the closure member 20, and which extends between the outside and inside-facing surfaces 24 and 25, respectively. The latch 10 further comprises a latch housing 30, which is mounted on the inside facing surface 24 of the closure member 20. The latch housing 30 is defined by a proximal end wall 35, which has a first aperture 51, and which is further substantially coaxially aligned with the latch aperture 26. Still further, the latch housing 30 further includes a second aperture 52. The latch housing 30 additionally defines an internal cavity 40, which encloses and otherwise defines a guidance channel 43, which is aligned, at least in part with the latch aperture 26. Still further, the internal cavity 40 of the latch housing 30 additionally defines, in part, a locking member passageway 60, which is substantially aligned with the second apertures 52. The main body 91 of the spindle 90 extends through the latch aperture 26, and the first end 92 of the main body 91 of the spindle 90 is located at times during operation in spaced relation relative to the outside-facing surface 24 of the closure member 20. This is seen most clearly by reference to 4C.

The latch 10 further comprises a biasing member 100, which acts upon the elongated spindle 90, and which further is located within the latch housing 30. The biasing member 100 urges the spindle 90 to move longitudinally, inwardly toward the internal cavity 40 of the latch housing 30. In the arrangement as seen in the drawings, the pinion 140 is located in the latch housing 30, and further, in part, within the locking member passageway 60 thereof. As noted earlier, the locking member 120 is biased downwardly into forcible engagement by the pinion 140. As earlier noted, the locking member 120 is reciprocally moveable along the path of travel 131, between a first extended position 132, where the second end 122 of the locking member 120 is positioned outwardly through the second aperture 52, as defined by the latch housing 30 and engages the sidewall of the storage container 11 and thereby secures the closure member in an occluding position relative to the aperture 114, which is defined by the storage container 11. This is seen most clearly by reference to FIG. 6A. Still further, the locking member 120 is moveable to the second position 133. In the second, retracted position 123, the second end 122 of the locking member 120 is moved to a location where the second end 122 does not engage the sidewall 13 of the closure member 20, and the closure member 20 is able to be moved to a non-occluding position which allows access to the internal cavity 15 of the storage container 11. As earlier described, the rack 125 is mounted on or made integral with a bottom surface 124 of the locking member 120, and is meshingly engaged by the pinion 140. The rotation of the pinion 140 in a given direction is operable to impart reciprocal motion to the locking member 120, so as to move the locking member 120 between the first and second positions 132 and 133, respectively.

In the arrangement as seen in the drawings, the latch 10 includes a latch control collar 110, having an engagement member 114, which is slidably received within and cooperates with the guidance channel 43. The engagement member 114, when received within the guidance channel 43, substantially prevents rotation of the spindle 90, and any corresponding and substantial movement of the locking member 120. The longitudinal movement of the spindle 90, and latch control member 110, along the guidance channel 43, by the application of a longitudinally and outwardly directed drawing or pulling force applied by a user to the existing doorknob or cabinet pull 27, and to a location where the engagement member 114 is no longer in the guidance channel 43, allows the spindle 90 to be subsequently selectively rotated 174 in a given direction so as to effect the reciprocal motion of the locking member 120 into, and out of, the engagement with, the sidewall 13, which defines, in part, the aperture 14 of the storage container 11. As will be appreciated by a study of the drawings, the guidance channel 43 has an elongated first course 45, which is substantially aligned with the latch aperture 26, and which is further perpendicular to the locking member passageway 60. The guidance channel 43 further has a second course 46, which is substantially transverse to the first course 45. It should be understood that an outwardly directed and longitudinally applied force to the second end 93 of the spindle 90 by the application of force to the existing doorknob 27, causes the second end 93 of the spindle 90 to be drawn longitudinally, outwardly away from the outside-facing surface 24 of the closure member 20, and further causes the engagement member 114 to move along the first course 45, and be aligned with the second course 46. As will be appreciated, on a subsequent rotation 174 of the spindle 90, the rotation is effective in moving the engagement member 114 along the second course 46, and out of mating engagement therewith. Subsequently, when the spindle is then rotated 174 in a given direction, such rotatable motion 174 is effective in imparting a simultaneous rotation of the pinion 140, and a corresponding movement of the locking member 120 as the pinion 140 meshingly and forcibly engages the rack 125, which is made integral with the locking member 120. As will be appreciated, this longitudinal outward movement of the spindle, as described above, moves the first end of the spindle 92 longitudinally within the passageway 143, as defined by the pinion 140. The motion of the engagement member is best seen in FIGS. 4D and 4E, respectively.

The latch 10 of the present invention, as earlier described, includes a biasing member 100, which is located between the latch housing 30, and the latch control collar 110. The spindle 90 further passes through the latch control collar 110, and the engagement member 114 extends substantially perpendicular outwardly relative to the spindle 90. The biasing member 100 is effective in biasing the spindle 90, along the first course 45, of the guidance channel 43, when the engagement member 114 is received in the first course 45 of the guidance channel 43, and the outwardly and longitudinally directed force is no longer applied to the spindle 90 by way of the existing doorknob or cabinet pull 27. The latch of the present invention 10 further includes a second biasing member 130, which is received within the latch housing 30, and which further applies a biasing force thereagainst the locking member 120 so as to maintain the locking member 120 in meshing cooperation, and force receiving relation relative to the pinion 140. As seen in the drawings, the pinion 140 remains in meshing force transmitting relation relative to the rack 120, which is made integral with the locking member 120 as the spindle is drawn longitudinally outwardly relative to the closure member 20. As illustrated in the drawings the spindle 90 is mounted in spaced relation relative to the guidance channel 43.

Therefore, it will be seen that the latch 10 of the present invention provides many advantages over the prior art devices which have been utilized heretofore. The latch 10 of the present invention is easy to install, utilizes the existing aperture formed in a closure member 20, and further allows a homeowner, for example, to use existing doorknobs or cabinet pulls thereby allowing the homeowner to maintain the exterior appearance of their cabinets or other storage units. Additionally, the present latch is easy to operate, is reliable, and most importantly, is difficult or impossible to operate for a young child, thereby allowing a parent to secure various cabinets and storage containers in a manner not possible heretofore. Additionally, such locking or other latch assembly can be installed without the use of any substantial tools or any alteration to the cabinet or other storage unit thereby allowing the homeowner to easily remove the latch when it is no longer needed.

In compliance with the statute, the invention has been described in language more or less specific as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. A latch for securing a storage container, comprising:
a storage container having a sidewall which defines an internal cavity, and an aperture which allows access to the internal cavity;
a closure member movably cooperating with the storage container and which selectively occludes the aperture, and prevents access to the internal cavity, and may be further located in a non-occluding position which allows access to the internal cavity;
a spindle having a main body which passes through the closure member, and which is further longitudinally and rotatably moveable relative to the closure member, and wherein the main body has opposite first, and second ends;
an elongated locking member which is oriented in force receiving relation relative to the spindle, and wherein the rotation of the spindle imparts force to the elongated locking member to move the elongated locking member along a path of travel into, and out of engagement with the sidewall of the storage container so as to selectively retain the closure member in the occluding position relative to the aperture, and which is defined by the storage container, or allow the closure member to be moved to the non-occluding position relative to the aperture as defined by the storage container; and
a latch control collar which is mounted on the spindle, and which is moveable along a course of travel, from a first position, which substantially prevents rotation of the spindle, and any subsequent movement of the elongated locking member, and a second position, which allows the spindle to be simultaneously rotated so as to impart movement to the elongated locking member.

2. A latch as claimed in claim 1, and further comprising:
a pinion which is longitudinally, moveably mounted on the second end of the main body of the spindle, and which is further co-rotatable with the spindle, and wherein the elongated locking member further has a rack which is oriented in meshing, force receiving relation relative to the pinion, and wherein the co-rotation of the spindle and the pinion moves the elongated locking member along the path of travel, and wherein the spindle passes through an existing aperture formed in the closure member, and wherein an existing handle from the closure member is releasably affixed to the first end of the spindle.

3. A latch as claimed in claim 2, and wherein the closure member has an outside facing, and an opposite, inside facing surface, and wherein a latch aperture is formed in the closure member, and which extends between the outside and inside facing surfaces, and wherein the latch further comprises a latch housing which is mounted on the inside facing surface of the closure member, and wherein the latch housing is defined by a sidewall which has a first aperture which is substantially coaxially aligned with the latch aperture which is formed in the closure member, and a second aperture, and wherein the latch housing further defines an internal cavity which further encloses a guidance channel which is aligned, at least in part, with the latch aperture, and a locking member passageway which is substantially aligned with the second aperture which is defined by the latch housing.

4. A latch as claimed in claim 3, and wherein the main body of the spindle extends through the latch aperture, and the first end of the main body of the spindle is located in spaced relation relative to the outside facing surface of the closure member, and wherein the latch further comprises a biasing member which acts upon the elongated spindle, and which further is located within the latch housing, and wherein the biasing member urges the spindle to move longitudinally, inwardly toward the internal cavity of the latch housing.

5. A latch as claimed in claim 4, and wherein the pinion is located in the latch housing, and within the locking member passageway thereof, and wherein the locking member is biased into forcible engagement by the pinion, and wherein the locking member is reciprocally moveable along the path of travel between a first, extended position, where the second end of the locking member extends outwardly through the second aperture as defined by the latch housing, and engages the sidewall of the storage container, and thereby secures the closure member in the occluding position relative to the aperture which is defined by the storage container, and a second, retracted position, and wherein in the second, retracted position, the second end of the locking member is moved to a location where the second end does not engage the sidewall of the closure member, and the closure member is able to be moved to the non-occluding position which allows access to the internal cavity of the storage container, and wherein the rack is formed in a top surface of the locking member and is meshingly engaged by the pinion, and wherein rotatable motion of the pinion in a given direction is operable to impart reciprocal motion to the locking member to move the locking member between the first and second positions thereof.

6. A latch as claimed in claim 5, and wherein the latch control collar has as an engagement member which is slidably received within, and cooperates with the guidance channel, and wherein the engagement member when received within the guidance channel, substantially prevents rotation of the spindle, and any corresponding movement of the locking member, and wherein the longitudinal movement of the spindle, and the latch control collar along the guidance channel, and to a location where the engagement member is no longer in the guidance channel allows the spindle to be subsequently, selectively rotated in a given direction so as to effect the reciprocal motion of the locking member into, and out of engagement with the sidewall which defines the aperture of the storage container.

7. A latch as claimed in claim 6, and wherein the guidance channel has an elongated first course which is substantially aligned with the latch aperture, and which is further perpendicular to the locking member passageway, and a second course, which is substantially transverse to the first course, and wherein an outwardly directed force applied to the first end of the spindle causes the first end of the spindle to be withdrawn longitudinally, outwardly away from the outside facing surface of the closure member, and further causes the engagement member to move along the first course, and be aligned with the second course, and wherein a subsequent rotation of the spindle is effective in moving the engagement member along the second course, and out of mating engagement therewith, and wherein the spindle is then rotatable in a given direction, and where such rotatable motion is effective in imparting a simultaneous rotation of the pinion, and a corresponding movement of the locking member, as the pinion meshingly, and forcibly engages the rack which is made integral with the locking member.

8. A latch as claimed in claim 7, and wherein the biasing member is located between the latch housing, and the latch control collar, and wherein the spindle further passes through the latch control collar, and the engagement member extends substantially perpendicularly outwardly relative to the spindle.

9. A latch as claimed in claim 8, and wherein the biasing assembly is effective in biasing the spindle along the first course of the guidance channel when the engagement member is received in the guidance channel and outwardly directed longitudinal force is not applied to the spindle.

10. A latch as claimed in claim 9, and further comprising a second biasing member received within the latch housing, and which further applies a biasing force thereagainst the locking member so as to maintain the locking member in meshing cooperation and force receiving relationship relative to the pinion.

11. A latch as claimed in claim 10, and wherein the pinion remains in meshing, force transmitting relation relative to the rack which is made integral with the locking member as the spindle is drawn longitudinally outwardly relative to the closure member.

12. A latch as claimed in claim 11, and wherein the spindle is mounted in spaced relation relative to the guidance channel.

13. A latch for securing a storage container, comprising:
a closure member having opposite, inside and outside facing surfaces, and which is further moveably mounted on a storage container that has an internal cavity, and which further defines an aperture which allows access into the internal cavity, and wherein the closure member is moveable relative to the storage container between a first position, where the closure member occludes the aperture, and prevents access to the internal cavity, and a second, spaced position, which allows access to the internal cavity, and wherein the storage container has a frame member which defines, at least in part, the aperture, and wherein a latch aperture is formed in, and passes through the inside and outside facing surfaces of the closure member;
a latch housing mounted on the inside facing surface of the closure member, and wherein the latch housing is defined by a sidewall which has a first aperture which is substantially coaxially aligned with the latch aperture formed in the closure member, and a second aperture, and wherein the latch housing further defines an internal cavity which further encloses a guidance channel which is aligned, at least in part, with the latch aperture, and a locking member passageway which is substantially aligned with the second aperture which is defined by the latch housing;
an elongated spindle having a main body which extends through the latch aperture, and which further has a first end, which is located in spaced relation relative to the outside facing surface of the closure member, and a second end, which is located in spaced relation relative to the inside facing surface thereof, and within the internal cavity of the latch housing;
a biasing member which acts upon the elongated spindle, and which further is located within the latch housing, and wherein the biasing member urges the spindle to move longitudinally, inwardly toward the internal cavity of the latch housing;
a pinion mounted on the second end of the elongated spindle, and which is further located within the locking member passageway, and wherein the pinion is co-rotatable with the spindle, and is further slidably moveable along the spindle between the first and second ends thereof;
a locking member having an elongated main body with opposite first and second ends, and a top and bottom surface, and wherein the elongated main body is received within the locking member passageway, and is reciprocally moveable along a path of travel between a first, extended position, where the second end of the locking member extends outwardly through the second aperture as defined by the latch housing, and which engages the frame member of the storage container, and thereby secures the closure member in the first occluding position relative to the aperture which is defined by the storage container, and a second, retracted position, and wherein in the second, retracted position, the second end of the locking member is moved to a location where the second end does not engage the frame member, and the closure member is able to be moved to the second position which allows access to the internal cavity of the storage container, and wherein a rack is formed in the top surface of the locking member and is meshingly engaged by the pinion, and wherein rotatable motion of the pinion in a given direction is operable to impart reciprocal motion to the locking member to move the locking member between the first and second positions thereof; and
a latch control collar mounted on the spindle, and which is co-rotatable, and simultaneously, longitudinally moveable with the spindle, and wherein the latch control member has as an engagement member which is slidably received within, and cooperates with the guidance channel, and wherein the engagement member when received within the guidance channel, substantially prevents rotation of the spindle, and any corresponding movement of the locking member, and wherein the longitudinal movement of the spindle, and latch control member along the guidance channel, and to a location where the engagement member is no longer in the guidance channel allows the spindle to be subsequently, selectively rotated in a given direction so as to effect the reciprocal motion of the locking member into, and out of engagement with the frame member which defines the aperture of the storage container.

14. A latch as claimed in claim 13, and wherein at least a portion of the guidance channel, and the locking member passageway are located in perpendicular relationship, one relative to the other.

15. A latch as claimed in claim 14, and wherein the guidance channel has an elongated first course which is substantially aligned with the latch aperture, and which is further perpendicular to the locking member passageway, and a second course, which is substantially transverse to the first course, and wherein an outwardly directed force applied to the first end of the spindle causes the first end of the spindle to be drawn longitudinally, outwardly away from the outside facing surface of the closure member, and further causes the engagement member to move along the first course, and be aligned with the second course, and wherein a subsequent rotation of the spindle is effective in moving the engagement member along the second course, and out of engagement therewith, and wherein the spindle is then rotatable in a given direction, and where such rotatable motion is effective in imparting a simultaneous rotation of the pinion, and a corresponding movement of the locking member, as the pinion meshingly, and forcibly engages the rack which is made integral with the locking member.

16. A latch as claimed in claim 15, and wherein the biasing member is located between the latch housing, and the latch control collar, and wherein the spindle further passes through the latch control collar, and the engagement member extends substantially perpendicularly outwardly relative to the spindle.

17. A latch as claimed in claim 16, and wherein the biasing assembly is effective in biasing the spindle in a direction so as cause the engagement member to be moved in the direction of the first course of the guidance channel when the engagement member is received in the guidance channel.

18. A latch as claimed in claim 17, and further comprising a second biasing member received within the latch housing, and which further applies a biasing force thereagainst the locking member so as to maintain the locking member in meshing cooperation and force receiving relationship relative to the pinion.

19. A latch as claimed in claim 18, and wherein the pinion remains in meshing, force transmitting relation relative to the rack which is made integral with the locking member as the spindle is withdrawn longitudinally outwardly relative to the closure member.

20. A latch as claimed in claim 19, and wherein the spindle is mounted in spaced relation relative to the guidance channel.
